(19) United States
(12) Patent Application Publication
(10) Pub. No.: US 2004/0106309 A1
(43) Pub. Date: Jun. 3, 2004

(54) DOUBLE-ENDED GROUNDING BOLT

(75) Inventors: Lars LARSSON, Goteborg (SE); Bo JACOBSSON, Torslanda (SE)

Correspondence Address: HOWREY SIMON ARNOLD & WHITE LLP, 1299 PENNSYLVANIA AVE., NW, BOX 34, WASHINGTON, DC, 20004, US

(73) Assignee: VOLVO TRUCK CORPORATION, Goteborg (SE)

(21) Appl. No.: 10/604,828

(22) Filed: Aug. 20, 2003

Related U.S. Application Data
(63) Continuation of application No. PCT/SE02/00114, filed on Jan. 23, 2002.

(30) Foreign Application Priority Data
Feb. 20, 2001 (SE) 0100562-8

(51) Int. Cl. H01R 4/66

(52) U.S. Cl. 439/92

(57) ABSTRACT

Method and arrangement for providing a grounding element (1) configured for assuring an electrical connection between a structural element and an electrical terminal and that includes a first portion (2) provided with a thread (5), a second portion (3) provided with a thread (6), and a central section (4) having a portion (4a) with at least one projecting ridge (7) that connects the first portion (2) to the second portion (3). The central section (4) has a first contact surface (8) in the plane where the central section (4) is connected to the second portion (3).

### CROSS REFERENCE TO RELATED APPLICATIONS

The present application is a continuation patent application of International Application No. PCT/SE02/00114 filed 23 Jan. 2002 which was published in English pursuant to Article 21(2) of the Patent Cooperation Treaty, and which claims priority to Swedish Application No. 0100562-8 filed 20 Feb. 2001. Both applications are expressly incorporated herein by reference in their entireties.

### BACKGROUND OF INVENTION

1. Technical Field

The present invention relates to a grounding element for making possible an electrical connection between a structural element and an electrical terminal of the type disclosed in EP-0641944-A1, and having U.S. Pat. No. 5,442,133, the disclosure of which is expressly incorporated herein by reference.

2. Background

There are a number of different known ways of connecting a ground connection to, for example, the frame of a heavy-duty vehicle.

Ground connections on vehicles do not normally create any problems. Grounding points are mounted in production in a sufficient number at predetermined positions on the vehicle so that all the equipment which is series-mounted, or can be ordered as manufacturer-specific optional equipment, has a prepared grounding point. The grounding points normally consist either of a grounding plate where flat pins or ring shoes can be mounted, or of a bolt where ring terminals can be attached. Grounding plates can, for example, be screwed or riveted to the chassis, and the bolt can consist of, for example, a spot-welded pin bolt.

An example of a spot-welded pin bolt is known through EP-0641944-A1, where a pin bolt for grounding purposes in series production is described. The described pin bolt is provided with a welding projection, an intermediate section and a threaded rod part. A nut is mounted on the rod part. The pin bolt is spot-welded rigidly to the vehicle and left untreated. The vehicle is then surface-treated and subsequently, in order for it to be possible to mount the grounding terminal, the nut is slackened off. This ensures that there is no paint on the contact surfaces to the grounding terminal.

On the other hand, problems associated with ground connections arise for constructors who mount optional equipment on heavy-duty vehicles. When this optional equipment is mounted, the frame of the vehicle has been surface-treated. It is therefore not possible in a simple manner to use the methods referred to above in order to create a grounding terminal. As there are so many different types of equipment and combinations of equipment which can be retrofitted on heavy-duty vehicles, it is neither possible nor desirable to standardly equip the vehicle with grounding points for all possible variants of optional equipment.

The most usual way of providing a grounding point for optional equipment on a heavy-duty vehicle is to attach a grounding plate to the vehicle. This is often carried out on the frame of the vehicle. A grounding terminal can then be fixed to this grounding plate. In most cases, the grounding plate is screwed on, using either a self-tapping screw, a through-bolt or a bolt in a hole tapped in the frame. The grounding plate can also be riveted on.

Another way of providing a grounding point is to spot-weld a pin bolt to the frame.

Although the abovementioned methods of retrofitting a grounding point function technically, they all have a number of disadvantages.

It is important that the grounding plate has electrical contact with the frame. In order to ensure reliable electrical contact, the contact surface between the grounding plate and the frame must be well cleaned of paint, corrosion-inhibiting coatings and other insulating materials. This terminal connection must then be protected so that it does not subsequently begin to corrode. Moreover, the attachment of the grounding plate must be sufficiently mechanically strong that it can take up the forces which act on it.

In order to achieve sufficient strength and for the grounding plate not to rotate, a grounding plate needs to be attached by two spaced apart fastening elements. As it is desirable to use existing hole groups, this results in the grounding plate being relatively large. At the same time, it can be difficult to find a free hole group. Sometimes new holes have to be made which is time-consuming.

Neither self-tapping screws nor a bolt screwed into a hole tapped in the frame afford sufficiently great strength. A frame element on, for example, a truck has different thickness depending on the type of truck and location on the truck. At its thinnest, a frame element may measure, for example, 7 mm, which provides too small an attachment area for these fastening elements to provide sufficiently strong attachment. This results in the electrical contact being unreliable. Furthermore, existing holes cannot be used for these types of fastening element, but new holes have to be prepared by hand.

Expensive and complicated equipment is required in order to rivet the plate on, and it is often difficult to reach using a riveting tool. The use of through-bolts is time-consuming and thus costly. Spot-welding pin bolts to the frame also requires expensive and complicated equipment, and electrical equipment on the vehicle has to be disconnected during spot-welding, which is time-consuming.

As far as all these methods are concerned, the overriding problem remains of having to remove paint and other insulating materials from the contact surface, which is labor-intensive as the frame has undergone many different surface treatments.

### SUMMARY OF INVENTION

An objective of the invention is, therefore, to provide a grounding element which makes possible an electrical connection between a structural element and an electrical terminal, which can be mounted in as simple, rapid and inexpensive a manner as possible, and whichoccupies little space while at the same time results in as reliable an electrical terminal as possible.

In at least one embodiment, the invention takes the form of a grounding element that comprises a first portion, a second threaded portion and a central section which connects the first portion to the second threaded portion, and where the first portion, the second threaded portion and the central section are centered along a common central axis and where the central section has a contact surface in the plane where the central section is connected to the second threaded portion. The objective of the invention is achieved by virtue of the fact that the first portion is provided with a thread and that the central section comprises a portion with at least one projecting ridge.

By way of the exemplary embodiment described above, a grounding element is provided that can be mounted in a simple manner, for example in the frame of, for example, a heavy-duty vehicle, so that electrical contact is established between the frame and the grounding element. The ridges create the electrical contact, on the one hand, by cutting through paint and other surface coatings on the frame, and on the other hand, by deforming the mounting hole so that metallic contact is brought about between the grounding element and the frame. A grounding terminal can then be mounted on the grounding element. The advantage of this is that a reliable grounding point is obtained in a simple, inexpensive manner.

In an advantageous first development or aspect of the grounding element configured according to the teachings of the invention, the central section comprises (includes, but is not limited to) a truncated cone, the tip end of which is connected to the first threaded portion. The advantage of this configuration is that greater tolerances of the mounting hole can be accepted while retaining the electrical contact.

In an advantageous second development or aspect of the grounding element configured according to the teachings of the invention, the central section comprises a disk-shaped portion. The advantage of this configuration is that the grounding element can also be used as a fastening element, for example, to beams or brackets.

In an advantageous third development or aspect of the grounding element configured according to the teachings of the invention, the thread on the second portion is deformed. The advantage of this configuration is, on the one hand, that the electrical contact between the threaded portion and the nut is better and, on the other hand, that the friction between the threaded portion and the nut increases so that the nut can no longer vibrate loose as easily.

In an advantageous fourth development or aspect of the grounding element configured according to the teachings of the invention, the contact surface which connects the central section to the second threaded portion is provided with one or a number of projections. The advantage of this configuration is, on the one hand, that the electrical contact between the contact surface and the electrical terminal is better and, on the other hand, that the electrical terminal is prevented from rotating during mounting.

In an advantageous fifth development or aspect of the grounding element configured according to the teachings of the invention, the edge of the disk-shaped portion is designed with at least two parallel surfaces. The advantage of this configuration is that the grounding element can be held in place or rotated by a tool.

### BRIEF DESCRIPTION OF DRAWINGS

The invention will be described in greater detail below with reference to illustrative embodiments shown in the accompanying drawings, in which:

FIG. 1 is an assembled, side elevational view showing a first embodiment of a grounding element configured according to the present inventive teachings;

FIG. 2 is an assembled, side elevational view showing a second embodiment of a grounding element configured according to the present inventive teachings;

FIG. 3 is an assembled, side elevational view showing a third embodiment of a grounding element configured according to the present inventive teachings;

FIG. 4 is an elevational side view of an assembled, but not tightened version of the present invention; and

FIG. 5 is an end elevational view of the exemplary embodiment of the ridged portion of the central section illustrated in FIG. 2.

### DETAILED DESCRIPTION

The illustrative embodiments of the invention described below, with developments, are to be regarded only as examples and are in no way to be limiting for the protective scope of the patent claims.

In the described embodiments, the same reference numbers in the various figures designate like components. Each component is therefore not described in detail with respect to each of the embodiments.

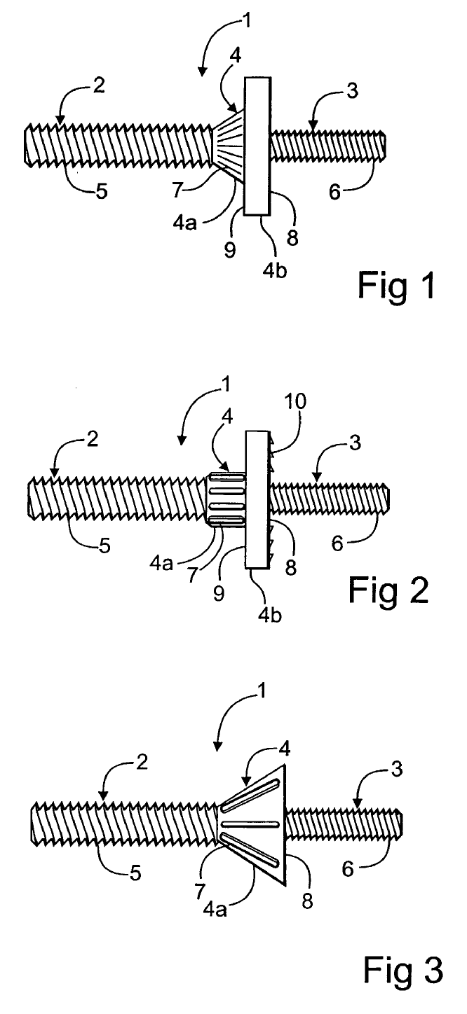

A first embodiment of a grounding element 1 that is configured is shown in FIG. 1 according to the teachings of the present invention and which comprises a first portion 2 provided with a thread 5, a second portion 3 provided with a thread 6, and a central section 4 which connects the first portion 2 to the second portion 3. The central section 4 comprises a portion 4a with a number of projecting ridges 7 and also a disk-shaped portion 4b. The side of the disk-shaped portion 4b facing the second portion 3 forms a first contact surface 8. The side of the disk-shaped portion 4b facing the first portion 2 forms a second contact surface 9.

The grounding element 1 is made from an electrically conductive material, for example a metal. It is advantageous for the material of the grounding element 1 to be harder than the material of the structural element in which the grounding element 1 is to be mounted. In this way, the ridges 7 can cut into the edge surfaces of the mounting hole and provide reliable electrical contact between the grounding element 1 and the structural element.

The threads on the first portion 2 and on the second portion 3 are advantageously a normal right-handed machine thread adapted for a nut, for example an M thread or a UN thread. It is advantageous for the first portion 2 to have the same thread as the fastening elements which are used for mounting equipment on the frame, for example M14. The second portion 3 should advantageously be provided with the same thread as is used for other similar grounding purposes on the vehicle, for example M10. It is advantageous for the diameter of the first portion 2 to be greater than, or the same as, the diameter of the second portion 3.

In terms of manufacture, it is advantageous to manufacture the grounding element 1 from a solid, circular blank so that the grounding element 1 is circular and so that the first portion 2, the second portion 3 and the central section 4 are centered along a common central axis, but other manufacturing methods and designs are also possible.

In the first embodiment, the grounding element 1 is intended to be mounted in the frame of, for example, a heavy-duty vehicle. In this example, the grounding element 1 is manufactured from a relatively high-strength steel, so that the ridges 7 can, on the one hand, cut through the surface treatment on the frame, and on the other hand, deform the mounting hole in the frame. In this case, the grounding element 1 is surface-treated with, for example, nickel or chromium as corrosion protection.

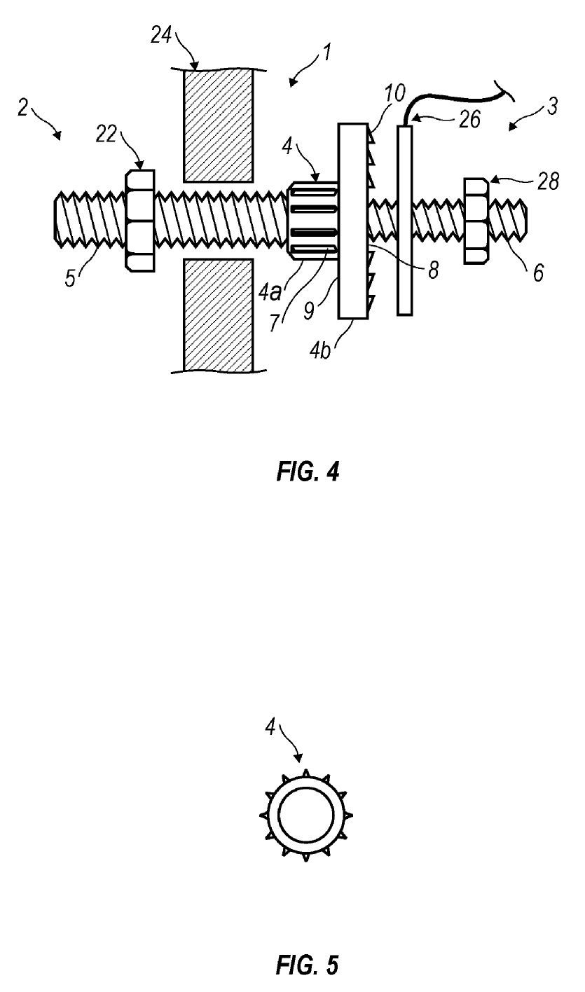

The grounding element 1 is mounted in a hole in the frame 24 or other supporting structure of the vehicle. As the grounding element 1 requires only one hole in order to be mounted, it is in most cases possible to use an existing hole in the frame 24. If there is no free hole close to the place where a grounding point is required, a hole can be made in a suitable location. The first portion 2 is positioned in the mounting hole and is secured by a nut 22 at the opposite side of the frame 24 as illustrated in FIG. 4. The nut 22 is tightened with a predetermined torque which guarantees that the grounding element 1 is braced between the mounting nut and the second contact surface 9 so that the element 1 is firmly fixed in the frame. It is advantageous for this torque to be the same as is used for the other fastening elements with the same thread dimensions, and it is therefore advantageous for the grounding element 1 to be dimensioned for this torque. This simplifies the mounting work and prevents the grounding element 1 from breaking by mistake when being tightened. When the nut has been tightened with the predetermined torque, the ridges 7 will have deformed the frame in such a manner that reliable electrical connection between the grounding element 1 and the frame is obtained. A major advantage of the grounding element 1 is that it is particularly suitable for use on surface-treated frames, as the ridges 7 cut through the surface treatment and provide more certain metallic contact between the grounding element and the frame. The surface treatment may be, for example, corrosion treatment and/or paint. Furthermore, the embedded ridges 7 prevent the grounding element 1 from rotating in the mounting hole.

The design of the ridges 7 is important for the functioning of the grounding element 1. The ridges 7 are dimensioned so that they can cut sufficiently into the material in which the grounding element 1 is to be mounted. Each ridge 7 is advantageously designed with a pointed cross section having a sharp top. The length of the base surface can be, for example, between half the height and the whole height of the ridge, but other shapes which provide good cutting-in are also possible. With the correct design of the ridges 7, the material where a ridge 7 deforms the frame will cold flow, which results in a gastight connection between the grounding element 1 and the frame. This renders corrosion of the connecting surfaces more difficult. The connection can of course be protected by a suitable anti-rust agent as an extra safeguard.

In this embodiment, the diameter of the widest part of the cone is preferably not greater than the cross section of the mounting hole. The inclination and the length of the cone is adapted to the dimensions and tolerances of the mounting hole. The cutting-in of the ridges is also dependent upon the material of the grounding element 1 and of the structural element.

As shown in FIG. 4, a grounding terminal 26 is typically mounted on the second portion 3 after the grounding element 1 has been mounted in the frame or support structure 24. The grounding terminal exemplarily consists of a grounding cable mounted, for example, as a ring shoe, but the use of other types of terminal connectors are also possible. The ring shoe is placed over the second portion 3 against the contact surface 8 and is secured by a nut 28. The grounding terminal will then have two contact surfaces; one between the contact surface 8 and the ring shoe, and one between the ring shoe and the second portion 3 via the nut.

As described in the first embodiment, the grounding element comprises the disk-shaped portion 4b. The advantage of this configuration is that the grounding element can be used for mounting structural elements, for example extra beams, brackets or the like, at the same time as establishing a grounding point. In this case, the disk-shaped portion 4b corresponds to the head on a bolt. It must be ensured, however, that the ridges on the grounding element can cut into the frame in a reliable manner. When a grounding element 1 is used for mounting structural elements, time is saved at the same time as better use can be made of existing holes because the grounding element 1 performs both as a fastener and as a reliable conductor for grounding purposes.

In a second embodiment of a grounding element, central section 4a is straight and axially oriented, as illustrated in FIG. 2. In this case, the diameter of the central section is dimensioned so that it is smaller than the mounting hole. The height and length of the ridges 7 are dimensioned so as to be capable of reliably cutting into the edge surfaces of the mounting hole taking into account the tolerances of the mounting hole. The cutting-in is also dependent on the material of the grounding element and of the receiving structural element 24.

In a first development, or version of that which is illustrated in FIG. 2, the disk-shaped portion 4b consists of a mechanical element with an internally threaded hole, which is mounted on the grounding element 1. The mechanical element can consist of, for example, a nut or a specially designed washer. The mechanical element is mounted on the grounding element 1 before the grounding element 1 is mounted on the structural element. The advantage of designing the disk-shaped portion 4b as a separate mechanical element is, on the one hand, manufacture-related, and on the other hand, facilitates the contact surface 8 being adapted to the terminal connector that will be received. This may concern, for example, different types of surface treatment, different projections and different cross sections. The mechanical element can be attached to the grounding element 1 by, for example, welding, upsetting or simply by a sufficiently great tightening torque that the threads are tensioned.

In a second development, the contact surface 8 is provided with one or a number of projection(s) 10. The projections 10 can be designed in a number of different ways. The role of the projections 10 is to improve the electrical contact between the contact surface and the electrical terminal. Moreover, the projections 10 prevent the electrical terminal from rotating during mounting. The projections 10 should therefore be low and relatively sharp so that they can deform the terminal element. There should also be many projections so that as many contact points as possible are formed. For example, the surface can be rough ground. This then produces a number of small raised points which facilitate good electrical contact. The surface can also be provided with, for example, small protuberances or a number of ridges.

FIG. 4 illustrates an assembled or installed version of the invention in which the elongate grounding element 1 is shown configured for affecting and facilitating an electrically grounded connection. The elongate grounding element 1 includes an elongate body having a longitudinal axis and at least an externally threaded portion 2,3. The threaded portion has an insertible portion 2 configured for non-threaded engagement with a support member 24 when inserted through a provided aperture in the support member. Means 4 for enhancing electrically conductive contact between the elongate body and the support member is provided and includes elongate ridges 7 radially extending off of a central portion of the elongate body. The central portion is configured for non-twisting insertion into the provided aperture in the support member in a direction substantially parallel to the longitudinal axis of the elongate body. The elongate ridges 7 form an interference fit with the support member 24 at a periphery of the provided aperture when the assembly is tightened. Details of the ridges included on the central portion can be better appreciated in the end view of the central portion or section 4 shown in FIG. 5.

In a third embodiment of a grounding element configured according to the invention, the element 1 comprises a central section 4 that consists of only a truncated cone 4a as exemplified in FIG. 3. The advantage of such a design is that the grounding element 1 can be adapted for a number of hole diameters. The grounding element 1 is also non-sensitive to hole tolerances. For example, the first portion 2 can be threaded with an M14 thread. The grounding element is then suitable for mounting in a 15.5 mm hole. If the greatest cross section of the cone, that is to say the diameter of the contact surface 8, is, for example, 24 mm, the grounding element 1 can be mounted in all holes between 15 and 20 mm and at the same time ensure reliable electrical contact between the grounding element 1 and the frame which simplifies stock-keeping. Conversely, this feature can also be used to prevent a grounding element intended for one hole dimension, for example 15.5 mm, from being mounted in a hole with an incorrect hole dimension, for example 17.5 mm.

In one development, the disk-shaped portion 4b is designed with at least two parallel surfaces. Advantageously, the perimeter edge is designed as a hexagon. The perimeter edge can then be used as a grip for a tool, for example a combination wrench or socket wrench. Using such a tool, it is possible to hold the grounding element 1 in place if, for any reason, it should start to rotate during mounting. Furthermore, the grounding element 1 can be removed using this type of tool if it needs to be removed and there is no room to knock it out. It is also possible to design the cone-shaped central section 4 according to FIG. 3 with a spanner grip. This can be done on that part of the edge of the cone which adjoins the contact surface 8.

In another development, the second portion 3 is designed with a deformed thread 6. This is done, on the one hand, in order to increase the electrical contact between the second portion 3 and the mounting nut, and on the other hand, in order to increase the friction between the second portion 3 and the mounting nut so that the nut cannot vibrate loose. The cross section can be made elliptical, for example, or it can be divided up symmetrically with more than two sides, for example a slightly triangular shape. The cross section can also be undulating with a suitable spacing. Another way of increasing the electrical contact and the friction is to deform the thread somewhat. For example, the threads 6 can be cut transversely to the thread direction, or they can be asymmetrical in the thread direction. The nut is then located securely without a special, self-locking nut having to be used.

The invention is not to be regarded as being limited to the illustrative embodiments and developments described above, but a number of further variants and modifications are possible within the scope of the following patent claims. For example, the grounding element can be used on all types of vehicle and with any type of electrical apparatus in which an electrical connection between a metallic structure and electrical terminals is desirable.

1. A grounding element (1) for making possible an electrical connection between a structural element and an electrical terminal, said grounding element (1) comprising:
a first portion (2);
a second portion (3) provided with a thread (6);
a central section (4) connecting the first portion (2) to the second portion (3) and the central section (4) having a first contact surface (8) in a plane where the central section (4) is connected to the second portion (3); and
the first portion (2) having a thread (5) and the central section (4) having a portion (4a) with at least one projecting ridge (7).

2. The grounding element as recited in claim 1, wherein the central section (4) further comprises a truncated cone (4a) having a tip end interconnected with the first portion (2).

3. The grounding element as recited in claim 1, wherein the central section (4) further comprises a disk-shaped portion (4b), one side surface of which forms the first contact surface (8).

4. The grounding element as recited in claim 3, wherein an edge of a disk-shaped portion (4b) of the central section (4) has at least two parallel surfaces.

5. The grounding element as recited in claim 4, wherein the disk-shaped portion (4b) is a mechanical element with an internally threaded hole, which is mounted on the grounding element (1).

6. The grounding element as recited in claim 1, further comprising a thread (6) on the second portion (3), the thread (6) being deformed.

7. The grounding element as recited in claim 1, wherein the first contact surface (8) is provided with at least one projection (10) extending therefrom.

8. An elongate grounding element for affecting and facilitating an electrically grounded connection, the elongate grounding element comprising:
an elongate body having a longitudinal axis and at least an externally threaded portion, said threaded portion having an insertible portion configured for non-threaded engagement with a support member when said threaded portion is inserted through a provided aperture in the support member; and
a means for enhancing electrically conductive contact between the elongate body and the support member, said enhancement means comprising elongate ridges radially extending off of a central portion of the elongate body, said central portion being configured for non-twisting insertion into the provided aperture in the support member in a direction substantially parallel to the longitudinal axis of the elongate body, said elongate ridges forming an interference fit with the support member at a periphery of the provided aperture.

9. A method for providing an elongate grounding element and affecting and facilitating an electrically grounded connection between the elongate grounding element and a receiving support structure, the method comprising:
providing an elongate grounding element having an elongate body establishing a longitudinal axis thereof and having at least an externally threaded portion;
inserting a part of said threaded portion through a provided aperture in the support member and thereby establishing non-threaded engagement of the elongate grounding element with the support structure;
enhancing electrically conductive contact between the elongate body and the support member by causing elongate ridges that radially extend off of a central portion of the elongate body to non-twistingly press into the provided aperture in the support member in a direction substantially parallel to the longitudinal axis of the elongate body; and
forming an interference fit between the elongate ridges and the support member thereby affecting and facilitating an electrically grounded connection between the elongate grounding element and the support structure.
